(19) United States
(12) Patent Application Publication
(10) Pub. No.: US 2023/0113318 A1
(43) Pub. Date: Apr. 13, 2023

(54) DATA AUGMENTATION METHOD, METHOD OF TRAINING SUPERVISED LEARNING SYSTEM AND COMPUTER DEVICES

(71) Applicant: BOE TECHNOLOGY GROUP CO., LTD., Beijing (CN)

(72) Inventors: Pablo NAVARRETE MICHELINI, Beijing (CN); Hanwen LIU, Beijing (CN)

(73) Assignee: BOE TECHNOLOGY GROUP CO., LTD., Beijing (CN)

(21) Appl. No.: 17/909,575

(22) PCT Filed: Mar. 18, 2021
(86) PCT No.: PCT/CN2021/081634

§ 371 Date: Sep. 6, 2022

(30) Foreign Application Priority Data
Mar. 20, 2020 (CN) 202010202504.7

(51) Int. Cl. G06N 3/09

(52) U.S. Cl. CPC G06N 3/09

(57) ABSTRACT

A data augmentation method includes: selecting at least two different sets of samples from an original data set, each set of samples including input samples and output samples; generating at least one random number; generating at least one extended input data sample according to input samples in the at least two different sets of samples and the at least one random number; and generating at least one extended output data sample according to output samples in the at least two different sets of samples and the at least one random number, each extended input data sample corresponding to a respective extended output data sample.

### CROSS-REFERENCE TO RELATED APPLICATIONS

This application is a national phase entry under 35 USC 371 of International Patent Application No. PCT/CN2021/081634, filed on Mar. 18, 2021, which claims priority to Chinese Patent Application No. 202010202504.7, filed on Mar. 20, 2020, which are incorporated herein by reference in their entirety.

### TECHNICAL FIELD

The present disclosure relates to the field of deep learning technologies, and in particular, to a data augmentation method, a method of training a supervised learning system, non-transitory computer-readable storage media and computer devices.

### BACKGROUND

In the past few years, many companies in the information technology market have invested heavily in the field of deep learning. Major companies like Google, Facebook, and Baidu have invested billions of dollars to hire leading research teams in this field and develop their own technologies. Other major companies follows closely, including IBM, Twitter, LeTV, Netflix, Microsoft, Amazon, Spotify, and the like. At present, the main purpose of this technology is for the solution of artificial intelligence (AI) problems such as recommendation engines, image classification, image captioning and searching, face recognition, age recognition, speech recognition. Generally speaking, the deep learning technology has been successful in the solution of human-like understanding of data, such as describing content of an image, recognizing objects in an image in difficult conditions, or recognizing speech in a noisy environment. Another advantage of deep learning is its generic structure which allows relatively similar systems to solve very different problems. Compared with previous methods, neural networks and deep learning structures are much larger in number of filters and layers.

### SUMMARY

In an aspect, a data augmentation method is provided. The data augmentation method includes: selecting at least two different sets of samples from an original data set; generating at least one random number; generating at least one extended input data sample according to input samples in the at least two different sets of samples and the at least one random number, and generating at least one extended output data sample according to output samples in the at least two different sets of samples and the at least one random number. Each set of samples includes input samples and output samples. Each extended input data sample corresponds to a respective extended output data sample.

In some embodiments, generating the at least one random number includes: generating the at least one random number greater than 0 and less than 1.

In some embodiments, generating the at least one random number greater than 0 and less than 1 includes: generating the at least one random number greater than 0 and less than 1 according to a uniform distribution.

In some embodiments, generating the at least one extended input data sample according to the input samples in the at least two different sets of samples and the at least one random number, and generating the at least one extended output data sample according to the output samples in the at least two different sets of samples and the at least one random number, includes: obtaining an extended input data sample through calculation according to x=α·x₁+(1−α)·x₂; and obtaining an extended output data sample corresponding to the extended input data sample through calculation according to y=α·y₁+(1−α)·y₂; wherein α is a random number, x and y are respectively the extended input data sample and the extended output data sample corresponding to the extended input data sample, x₁ and y₁ are respectively an input sample and an output sample of a set of samples, and x₂ and y₂ are respectively an input sample and an output sample of another set of samples.

In some embodiments, before selecting the at least two different sets of samples from the original data set, the data augmentation method further includes: performing a first image processing on input samples in the original data set; and/or, performing a second image processing on the input samples in the original data set. The first image processing includes at least one of inverting, translating or rotating images of the input samples. The second image processing includes changing at least one of a direction, a position, a ratio or brightness of the images of the input samples.

In another aspect, a method of training a supervised learning system is provided. The method of training the supervised learning system includes: augmenting a data set for training the supervised learning system according to the data augmentation method described in the above embodiments; and training the supervised learning system using the data set.

In yet another aspect, a non-transitory computer-readable storage medium is provided. The non-transitory computer-readable storage medium has stored thereon computer program instructions that, when run on a processor, cause the processor to perform the data augmentation method as described in the above embodiments.

In yet another aspect, a non-transitory computer-readable storage medium is provided. The non-transitory computer-readable storage medium has stored thereon computer program instructions that, when run on a processor, cause the processor to perform the method of training the supervised learning system as described in the above embodiments.

In yet another aspect, a computer device is provided. The computer device includes: a memory configured to store at least one of an initial result, an intermediate result or a final result; and at least one processor configured to perform: selecting at least two different sets of samples from an original data set; generating at least one random number; generating at least one extended input data sample according to input samples in the at least two different sets of samples and the at least one random number, and generating at least one extended output data sample according to output samples in the at least two different sets of samples and the at least one random number. Each set of samples includes input samples and output samples. Each extended input data sample corresponds to a respective extended output data sample.

In some embodiments, the processor is configured to perform: generating the at least one random number greater than 0 and less than 1.

In some embodiments, the processor is configured to perform: generating the at least one random number greater than 0 and less than 1 according to a uniform distribution.

In some embodiments, the processor is configured to perform: obtaining an extended input data sample through calculation according to x=α·x₁+(1−α)·x₂; and obtaining an extended output data sample corresponding to the extended input data sample through calculation according to y=α·y₁+(1−α)·y₂; wherein α is a random number, x and y are respectively the extended input data sample and the extended output data sample corresponding to the extended input data sample, x₁ and y₁ are respectively an input sample and an output sample of a set of samples, and x₂ and y₂ are respectively an input sample and an output sample of another set of samples.

In some embodiments, the processor is configured to perform: before selecting the at least two different sets of samples from the original data set, performing a first image processing on input samples in the original data set, and/or performing a second image processing on the input samples in the original data set. The first image processing includes at least one of inverting, translating or rotating images of the input samples. The second image processing includes changing at least one of a direction, a position, a ratio or brightness of the images of the input samples.

In yet another aspect, a computer device is provided. The computer device includes: a memory configured to store at least one of an initial result, an intermediate result or a final result; and at least one processor configured to perform: augmenting a data set for training a supervised learning system based on the data augmentation method as described in the above embodiments; and training the supervised learning system using the data set.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings in the following description may be regarded as schematic diagrams, and are not limitations on actual sizes of products, actual processes of methods and actual timings of signals involved in the embodiments of the present disclosure.

FIG. 1 is a schematic diagram of data augmentation in the related art;

FIG. 2 is a flow diagram of a data augmentation method, in accordance with some embodiments;

FIG. 3 is a schematic diagram of data augmentation, in accordance with some embodiments;

FIG. 4 is a flow diagram of another data augmentation method, in accordance with some embodiments;

FIG. 5 is a schematic diagram of a first image processing, in accordance with some embodiments;

FIG. 6 is a block diagram showing a structure of a data augmentation apparatus, in accordance with some embodiments;

FIG. 7 is a block diagram showing a structure of another data augmentation apparatus, in accordance with some embodiments;

FIG. 8 is a flow diagram of a method of training a supervised learning system, in accordance with some embodiments; and

FIG. 9 is a diagram showing a structure of a computer device, in accordance with some embodiments.

### DETAILED DESCRIPTION

Technical solutions in some embodiments of the present disclosure will be described clearly and completely below with reference to the accompanying drawings. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are only used for descriptive purposes, and are not to be construed as indicating or implying the relative importance or implicitly indicating the number of indicated technical features. Thus, features defined with “first” or “second” may explicitly or implicitly include one or more of the features. In the description of the embodiments of the present disclosure, the term “a plurality of” or “the plurality of” means two or more unless otherwise specified.

In the description of some embodiments, the expressions such as “coupled” and “connected” and derivatives thereof may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the content herein.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of the phrase “applicable to” or “configured to” herein means an open and inclusive language, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values exceeding those stated.

In the practical application process, developers usually compare multiple machine learning systems and determine which machine learning system is the most suitable for the problem to be solved through experiments (e.g., cross validation). However, it is worth noting that adjusting the performance of the learning system may be very time consuming. In a case where fixed resources are given, developers are usually willing to spend more time collecting more training data and more information, rather than spend more time adjusting the learning system.

A supervised learning system is a machine learning task of learning a function that maps an input to an output based on example input-output pairs. It infers functions from labeled training data containing a set of training examples. In the supervised learning system, each example appears in a pair consisting of an input object (typically a vector) and a desired output value (also called a supervisory signal). The supervised learning system will analyze the training data and produce an inferred function that can be used for mapping new examples. The optimal solution can correctly determine class labels of unseen examples.

When training a machine learning model, we adjust the parameters of the model according to the trained data set, so that it may map a specific input (e.g., an image) to a certain output (label). In a case where the parameters are adjusted correctly, the goal of training the machine learning model is to pursue the low loss of the model. Neural networks in the related art usually have parameters in the order of millions, and in the face of numerous parameters, a proportional amount input and output samples are needed to train the machine learning models to obtain good performance.

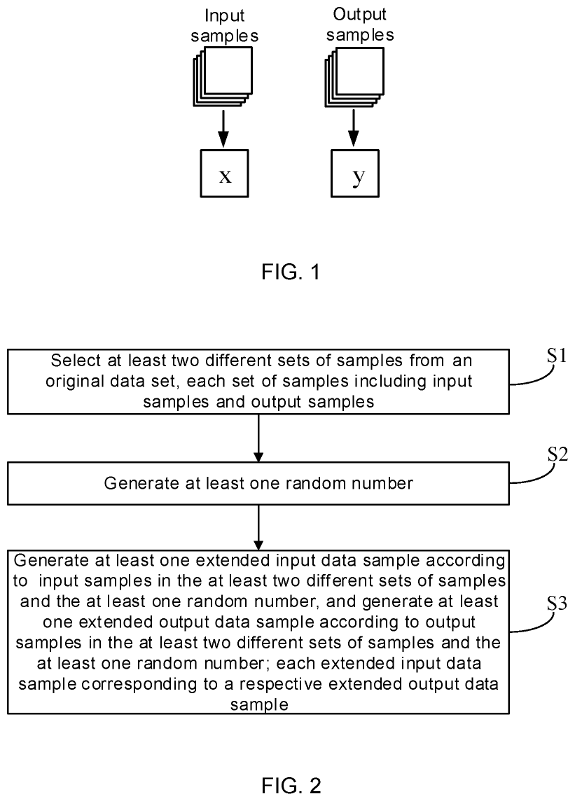

In the related art, according to the document “ImageNet Classification with Deep Convolutional Neural Networks” of the neural information processing system, the data set is artificially enlarged by using the label storage deformation technology. That is, a new deformed image is generated by performing a small amount of calculation on the images in the original data set. The data set is augmented by translating and horizontally reflecting a single image, or changing the RGB channels of a single image in the original data set. As shown in FIG.1, a new input sample x and a corresponding output sample y are obtained by modifying a single input sample and a single output sample in the original data set.

Although the methods in the above document can augment the data set, for the machine learning model with a large number of parameters that need to be trained, there is a large difference between the number of extensions and the desired high-performance model.

In light of this, some embodiments of the present disclosure provide a data augmentation method, which may be applied to the training of the supervised learning system to augment the data set used for training. As shown in FIG. 2, the method includes the following steps.

In S1, at least two different sets of samples are selected from an original data set, and each set of samples includes input samples and output samples.

The selected at least two different sets of samples may be two sets of samples, three sets of samples, or more sets of samples. The term “different” means that at least one sample of the input samples and the output samples in the at least two sets of samples is different. For example, it may be that in the at least two sets of samples, the input samples are different and the output samples are the same. Alternatively, it may be that in the at least two sets of samples, both the input samples and output samples are different.

In S2, at least one random number is generated.

The random number α may take an arbitrary value. That is, an infinite number of random numbers can be provided.

In S3, at least one extended input data sample is generated according to input samples in the at least two different sets of samples and the at least one random number, at least one extended output data sample is generated according to output samples in the at least two different sets of samples and the at least one random number, and each extended input data sample corresponds to a respective extended output data sample.

For a case where the number of samples in the original data set is small in the related art, the data augmentation method provided by some embodiments of the present disclosure may generate at least one extended input data sample (that is, a new input sample) according to the input samples in the at least two different sets of samples and the at least one random number, and generate at least one extended output data (that is, a new output sample) corresponding to the at least one extended input data sample according to the output samples in the at least two different sets of samples and the at least one random number. As a result, the original data set may be extended, and the training data in the original data set may be generalized to an infinite amount.

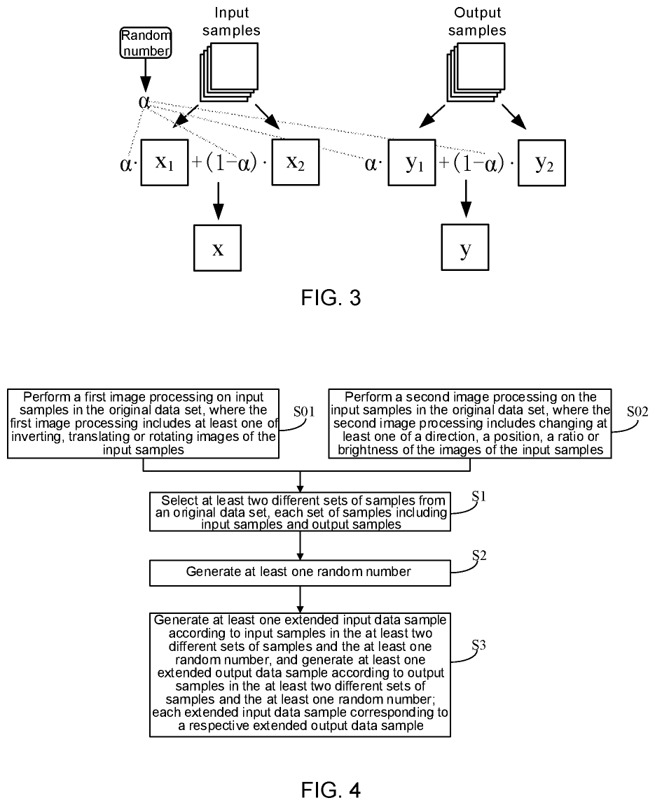

For example, as shown in FIG. 3, the selected at least two different sets of samples include two sets of samples, and the data set may be augmented according to the following steps.

Firstly, two different sets of samples are selected from the original data set, the first set of samples includes a first input sample x₁ and a first output sample y₁ corresponding to the first input sample x₁, and the second set of samples includes a second input sample x₂ and a second output sample y₂ corresponding to the second input sample x₂. The first input sample x₁ is different from the second input sample x₂, and the first output sample y₁ and the second output sample y₂ may be the same or different.

Secondly, at least one random number that is greater than 0 and less than 1 is generated. For example, the random number α may be 0.1, 0.2, 0.4, 0.5, 0.7, 0.8, etc. In some examples, generating the random number that is greater than 0 and less than 1 includes: generating the at least one random number that is greater than 0 and less than 1 according to a uniform distribution.

Finally, an extended input data sample x is generated according to the first input sample x₁, the second input sample x₂ and any random number α, and an extended output data sample y corresponding to the extended input data sample x is generated according to the first output sample y₁, the second output sample y₂ and the random number α.

For example, as shown in FIG. 3, the extended input data sample is obtained through calculation according to x=α·x₁+(1−α)·x₂, and the extended output data sample corresponding to the extended input data sample is obtained through calculation according to y=α·y₁+(1−α)·y₂.

Where α is a random number, x₁ and y₁ are respectively the input sample and the output sample of a set of samples, and x₂ and y₂ are respectively the input sample and the output sample of another set of samples.

Based on the above solution, new input samples and new output samples may be generated to augment the data set according to an input sample image and a corresponding output sample result that are in the first set, an input sample image and a corresponding output sample result that are in the second set, and the random number α. That is, the training data in the data set may be generalized to an unseen situation, thereby effectively augmenting the original data set. As shown in FIG. 3, considering two different sets of samples as an example, the extended input data sample x (i.e., the new input sample) is generated according to the random number α, the first input sample xi and the second input sample x₂, and the extended output data sample y (i.e., the new output sample) is generated according to the random number α, the first output sample y₁ and the second output sample y₂. The extended input data sample x is a linear combination of the first input sample x₁ and the second input sample x₂, and the extended output data sample y is a linear combination of the first output sample y₁ and the second output sample y₂. As a result, it may be applied to train the machine learning model based on the supervised learning system, so as to achieve extensions of the original data set.

Considering that after an image processing performed on an input sample in the original data set, the neural network will recognize the input sample as a different image, which can further augment the original data set. In some embodiments, in order to further extend the number of samples in the data set, before selecting the at least two different sets of samples from the original data set, as shown in FIG. 4, the data augmentation method further includes the following step.

In S01, a first image processing is performed on input samples in the original data set, where the first image processing includes at least one of inverting, translating, or rotating images of the input samples.

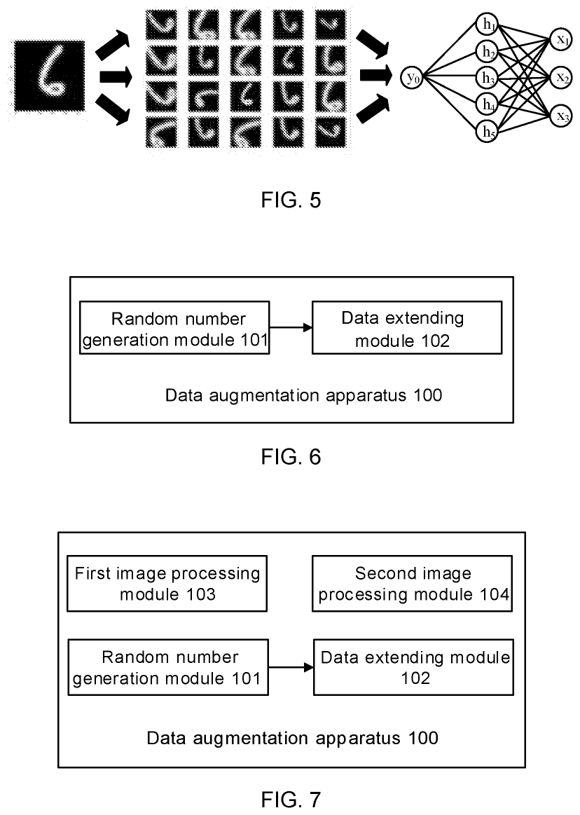

For example, as shown in FIG. 5, the image of the input sample is inverted, translated or rotated to obtain different sample data (e.g., the input samples x₁, x₂, x₃) may be obtained. Alternatively, the image of the input sample is inverted and translated simultaneously, or translated and rotated simultaneously to obtain different sample data (e.g., the input samples x₁, x₂, x₃). Moreover, as shown in FIG. 5, the obtained different input samples may correspond to a same output sample yo.

In order to further extend the number of samples in the data set, in some other embodiments, before selecting the at least two different sets of samples from the original data set, as shown in FIG. 4, the data augmentation method further includes the following step.

In S02, a second image processing is performed on the input samples in the original data set, where the second image processing includes changing at least one of a direction, a position, a ratio or brightness of the images of the input samples.

Considering that there are currently a large number of models to be trained that can only obtain a data set of sample images taken for training under limited conditions, in practical applications, the models may each process test images that are under different conditions. Therefore, in some embodiments of the present disclosure, the data set may also be augmented by changing some features of the images of the input samples in the original data set. For example, the direction of the images of the input samples is changed, which is implemented by adjusting directions of different objects in the images of the input samples. For example, the position of the images of the input samples is changed, which is implemented by adjusting positions of different objects in the images of the input samples For example, the brightness of the images of the input samples is changed, which is implemented by adjusting the brightness of different color channels in the images of the input samples. For example, the ratio of the images of the input samples is changed, which is implemented by adjusting the ratios of different objects in the images of the input samples. Alternatively, the data set may be augmented by comprehensively adjusting the features of the images of the input samples for training the machine learning model, so as to obtain the high-performance model.

It is worth noting that in order to further augment the data set, the above-mentioned image processing may also be performed on the images of the input samples in the original data set simultaneous. For example, the images of the input samples are inverted and brightness thereof is changed, so as to augment the data set. The image processing is not limited in the embodiments of the present disclosure, and any deformation based on the above principle is within the protection scope of the present disclosure. Those skilled in the art should choose appropriate image processing to augment the original data set according to actual application requirements, and details are not repeated here.

Corresponding to the data augmentation method provided in some embodiments described above, some embodiments of the present disclosure further provide a data augmentation apparatus 100. Since the data augmentation apparatus 100 provided by some embodiments of the present disclosure corresponds to the data augmentation method provided in some embodiments described above, the previous embodiments are also applicable to the data augmentation apparatus 100 provided in some embodiments of the present disclosure, and details are not described in this embodiment.

As shown in FIG. 6, some embodiments of the present disclosure further provide a data augmentation apparatus 100, which includes a random number generation module 101 and a data extending module 102. The random number generation module 101 is configured to generate at least one random number. The data extending module 102 is configured to: select at least two different sets of samples from an original data set, each set of samples including input samples and output samples; generate at least one extended input data sample according to input samples in the at least two different sets of samples and the at least one random number; and generate at least one extended output data sample according to output samples in the at least two different sets of samples and the at least one random number. The extended input data sample corresponds to the extended output data sample.

Beneficial effects of the data augmentation apparatus 100 provided by some embodiments of the present disclosure are the same as the beneficial effects of the data augmentation method in some embodiments described above, and details will not be repeated here.

In some embodiments, the random number generation module 101 is configured to generate the at least one random number greater than 0 and less than 1.

In some embodiments, the random number generation module 101 is configured to generate the at least one random number greater than 0 and less than 1 according to a uniform distribution. That is, it can provide an infinite number of random numbers to infinitely augment the data set.

In some embodiments, the data extending module 102 is configured to: obtain an extended input data sample through calculation according to x=α·x₁+(1−α)·x₂, and obtain an extended output data sample corresponding to the extended input data sample through calculation according to y=α·y₁+(1−α)·y₂. Where α is a random number, x₁ and y₁ are respectively an input sample and an output sample corresponding to the input sample of a set of samples in the original data set, and x₂ and y₂ are respectively an input sample and an output sample corresponding to the input sample of another set of samples in the original data set. The extended input data sample is a linear combination of the input sample x₁ and the input sample x₂, and the extend output data sample is a linear combination of the output sample yi and the output sample y₂.

In some embodiments of the present disclosure, the data set is augmented to an infinite number of linear combinations by mixing limited and available input samples and output samples in the original data set, and the implementations are the same as the foregoing embodiments, which will not be repeated here.

In some embodiments, as shown in FIG. 7, the data augmentation apparatus 100 further includes a first image processing module 103 configured to perform at least one of inversion, translation or rotation on the images of the input samples in the original data set. That is, the data set is further augmented by performing image processing such as inversion and translation on the images of the input samples in the original data set, and the implementations are the same as the foregoing embodiments, which will not be repeated here.

In some other embodiments, as shown in FIG. 7, the data augmentation apparatus 100 further includes a second image processing module 104 used to change at least one of the direction, the position, the ratio, and the brightness of the images of the input samples in the original data set. That is, the data set is further augmented by changing the direction, the ratio, and the like of the images of the input samples in the original data set, and the implementations are the same as the foregoing embodiments, which will not be repeated here.

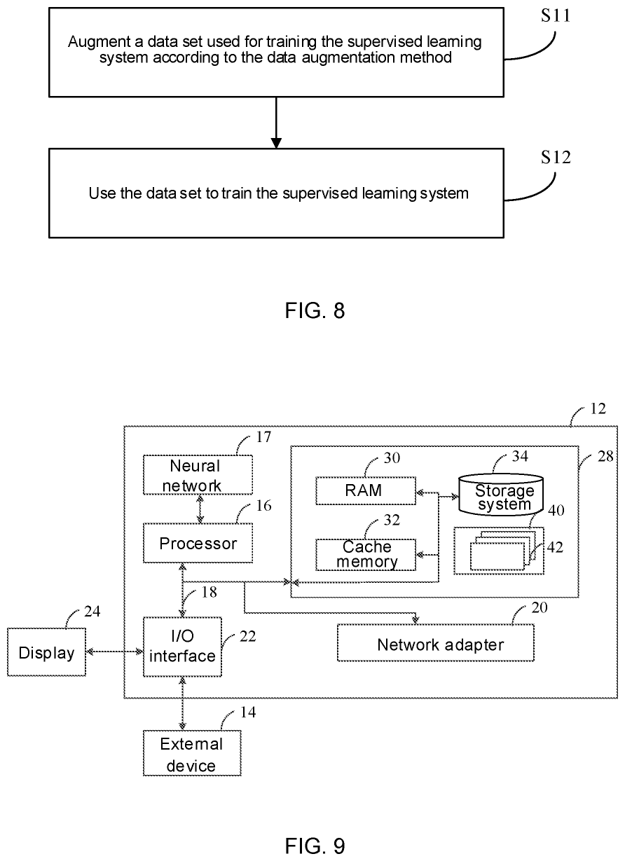

Based on the aforementioned data augmentation method, as shown in FIG. 8, some embodiments of the present disclosure further provide a method of training a supervised learning system, and the method includes the following steps.

In S11, a data set used for training the supervised learning system is augmented according to the above data augmentation method.

In S12, the supervised learning system is trained using the data set.

In some embodiments of the present disclosure, the original data set may be effectively augmented through the aforementioned data augmentation method to obtain a training data set, and then the training data set is used to train the supervised learning system to obtain a high-performance machine learning model.

Similarly, referring to FIG. 9, based on the aforementioned data augmentation apparatus 100, some embodiments of the present disclosure further provide a neural network 17 based on the supervised learning system, and the neural network 17 includes the data augmentation apparatus 100.

In some embodiments of the present disclosure, the neural network 17 may augment a data set with only a small number of training samples using the data augmentation apparatus 100, so as to adjust a large number of parameters of the neural network, thereby obtaining the high-performance machine learning model.

Some embodiments of the present disclosure provide a computer-readable storage medium (e.g., a non-transitory computer-readable storage medium), and the computer-readable storage medium has stored thereon computer programs. When executed by a processor, the programs implement: selecting at least two different sets of input samples and output samples from the original data set of the trained supervised learning system; generating at least one random number; generating at least one extended input data sample according to the at least two sets of different input samples and the at least one random number, and generating at least one extended output data sample according to the at least two sets of different output samples and the at least one random number. Each extended input data sample corresponds to a respective extended output data sample.

Some embodiments of the present disclosure provide another computer-readable storage medium (e.g., another non-transitory computer-readable storage medium), and the computer-readable storage medium has stored thereon computer programs. When executed by the processor, the programs implement: augmenting the data set used for training the supervised learning system according to the above data augmentation method, and training the supervised learning system using the data set.

In practical applications, the computer-readable storage medium may employ any combination of one or more computer-readable medium. The computer-readable medium may be a computer-readable signal medium or a computer-readable storage medium. For example, the computer-readable storage medium may be, but not limited to, an electronic, magnetic, optical, electromagnetic, infrared, or semiconductor system, apparatus, or device, or any combination of the foregoing. More specific examples (a non-exhaustive list) of the computer-readable storage medium include an electrical connection having one or more wires, a portable computer disk, a hard disk, a random access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination of the foregoing. In the embodiments, the computer readable storage medium may be any tangible medium that includes or stores programs, and the programs may be used by or in conjunction with an instruction execution system, an apparatus or a device.

The computer-readable signal medium may include data signal propagated in a baseband or as a part of carrier waves, and it carries computer-readable program codes thereon. Such propagated data signals may adopt a variety of forms, including but not limited to, electromagnetic signals, optical signals or any suitable combination of the foregoing. The computer-readable signal medium may also be any computer-readable medium other than the computer-readable storage medium, and the computer-readable medium may send, propagate or transmit a program used by or in conjunction with an instruction execution system, an apparatus or a device.

The program codes included in the computer-readable medium may be transmitted with any suitable medium, including but not limited to, radio, electric wire, optical cable, radio frequency (RF) or the like, or any suitable combination of the foregoing.

Computer program codes for carrying out operations of the embodiments of the present disclosure may be written in one or more programming languages or a combination thereof. These programming languages include object-oriented programming languages such as Java, Smalltalk, C++, and conventional procedural programming languages such as “C” programming language or similar programming languages. The program codes may be entirely executed on the user's computer, or partly executed on the user's computer, or executed as a stand-alone software package, or partly executed on the user's computer and partly executed on a remote computer, or entirely executed on the remote computer or on the server. In the scenario involving the remote computer, the remote computer may be connected to the user's computer through any type of network, including a local area network (LAN) or a wide area network (WAN), or the connection to an external computer (e.g., the connection through the Internet of an Internet Service Provider).

As shown in FIG. 9, FIG. 9 is a schematic diagram showing a structure of a computer device 12 provided by some embodiments of the present disclosure. The computer device 12 shown in FIG. 9 is only an example, and should not impose any limitations on the function and the scope of use of the embodiments of the present disclosure.

As shown in FIG. 9, the computer device 12 is represented in the form of a general-purpose computing device. Components of the computer device 12 may include, but are not limited to: one or more processors 16, a neural network 17, a system memory 28, and a bus 18 connecting various system components (including the system memory 28, the neural network 17 and the processors 16).

The neural network 17 includes, but is not limited to, a feedforward network, a convolutional neural network (CNN), or a recursive neural network (RNN).

The feedforward network may be implemented as an acyclic graph, in which nodes are arranged in layers. Typically, the feedforward network topology includes an input layer and an output layer that are separated by at least one hidden layer. The hidden layer transforms the input received by the input layer into a representation that may be used to generate output in the output layer. Network nodes are fully connected to nodes in adjacent layers via edges, but there are no edges between nodes in each layer. The data received at the nodes of the input layer of the feedforward network is propagated (i.e., “feedforward”) to the nodes of the output layer via an activation function, and the activation function calculates the states of the nodes of each successive layer in the network based on coefficients (“weight”) associated with each of the edges connecting the layers. Depending on the specific model represented by the algorithm being executed, the output from the neural network algorithm may take various forms.

The convolutional neural network (CNN) is a specialized feedforward neural network used to process data with a known grid-like topology, for example, image data. Therefore, CNN is usually used for computer vision and image recognition applications, but CNN may also be used for other types of mode recognition, such as speech and language processing. The nodes in the CNN input layer are organized into a set of “filters” (feature detectors inspired by the receptive fields found in the retina), and the output of each set of filters is propagated to nodes in successive layers of the network. The calculations for CNN include applying convolution mathematical operations to each filter produce the output of the filter. Convolution is a special type of mathematical operation performed by two functions to produce a third function, and the third function is a modified version of one of the two original functions. In convolutional network terminology, the first function of the convolution may be referred to as input, and the second function of the convolution may be referred to as convolution kernel. The output may be referred to as a feature map. For example, the input of the convolutional layer may be a multi-dimensional data array that defines various color components of the input image. The convolution kernel may be a multi-dimensional parameter array, and the parameters are adapted by the training process of the neural network.

The recurrent neural network (RNN) is a series of feedforward neural networks that include feedback connections between layers. The RNN achieves the modeling of sequential data by sharing parameter data across different parts of the neural network. The architecture of RNN includes circulation. The circulation represents the influence of the current value of the variable on its own value in the future, because at least a part of the output data from the RNN is used as feedback for processing subsequent inputs in the sequence. Due to the variable nature of language data that may be composed, this feature makes RNNs particularly useful for language processing.

The above-mentioned neural network may be used to perform deep learning. That is, the machine learning using a deep neural network provides the learned features to a mathematical model that may map the detected features to the outputs.

In some embodiments, the computer device further includes the bus 18 connecting various system components, and the bus 18 includes a memory bus or a memory control bus, a peripheral bus, an accelerated graphics port, and a processor or a local bus using any of a variety of bus structures. For example, these structures include, but are not limited to, an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus.

The computer device 12 may include a variety of computer system readable media. Such media may be any available media that can be accessible by the computer device 12, including both volatile and non-volatile media, and removable and non-removable media.

For example, the memory 28 includes computer system readable media in the form of volatile memory, such as a random access memory (RAM) 30 and/or a cache memory 32.

For example, the memory 28 further includes other removable or non-removable, volatile or non-volatile computer system storage media. For example only, a storage system 34 may be used for reading from and writing into a non-removable, non-volatile magnetic media (not shown in FIG. 9 and typically called a “hard drive”). Although not shown in FIG. 9, a magnetic disk drive for reading from and writing into a removable non-volatile magnetic disk (e.g., a “floppy disk”), and an optical disk drive for reading from or writing into a removable non-volatile optical disk (e.g., a CD-ROM, a digital versatile disk read-only memory (DVD-ROM) or other optical media) may be provided. In these situations, each drive may be connected to the bus 18 via one or more data media interfaces.

For example, the memory 28 further includes at least one program product 40, and the program product 40 has a set (e.g., at least one) of program modules 42 that are configured to carry out the functions of the above-mentioned embodiments. The program module 42 includes, but is not limited to, an operating system, one or more application programs, other program modules and program data. Each or some combination of these examples may include an implementation of a networking environment. The program module 42 usually carries out the functions and/or methods in some embodiments of the present disclosure as described herein.

In some embodiments, the computer device 12 communicates with at least one of the following devices: one or more external devices 14 (e.g., a keyboard, a pointing device, a display 24), one or more devices that enable a user to interact with the computer device 12, any devices (e.g., a network card, a modem) that enable the computer device 12 to communicate with one or more other computing devices. Such communication may be achieved via input/output (I/O) interfaces 22. Moreover, the computer device 12 may communicate with one or more networks (e.g., a local area network (LAN), a wide area network (WAN), and/or a public network such as the Internet) through a network adapter 20. As shown in FIG. 9, the network adapter 20 communicates with the other modules of the computer device 12 via the bus 18. It will be understood that although not shown in FIG. 9, other hardware and/or software modules may be used in conjunction with the computer device 12. The other hardware and/or software modules include, but are not limited to: microcodes, device drivers, redundant processing units, external disk drive arrays, redundant arrays of independent disks (RAID) systems, tape drives, data archival storage systems, and the like.

The processor 16 performs various functional applications and data processing by running the programs stored in the system memory 28. For example, the processor 16 implements a data augmentation method which is applied to the training of a supervised learning system ora method of training a supervised learning system provided by the embodiments of the present disclosure.

In view of the current existing problems, a data augmentation method, a method of training a supervised learning system, a data augmentation apparatus, a neural network, a computer-readable storage medium, and a computer device are provided in the embodiments of the present disclosure. The data set are augmented through random numbers and at least two different sets of input samples and output samples in the original data set, so that a problem that an effective neural network model cannot be obtained due to the small number of samples in the data set used for training the supervised learning system in the related art may be solved, and thus the existing problems in the related art can be made up, which has broad application prospects.

The foregoing descriptions are merely specific implementations of the present disclosure, but the protection scope of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

1. A data augmentation method, comprising:
selecting at least two different sets of samples from an original data set, each set of samples including input samples and output samples;
generating at least one random number; and
generating at least one extended input data sample according to input samples in the at least two different sets of samples and the at least one random number, and generating at least one extended output data sample according to output samples in the at least two different sets of samples and the at least one random number, each extended input data sample corresponding to a respective extended output data sample.

2. The data augmentation method according to claim 1, wherein generating the at least one random number, includes:
generating the at least one random number greater than 0 and less than 1.

3. The data augmentation method according to claim 2, wherein generating the at least one random number greater than 0 and less than 1, includes:
generating the at least one random number greater than 0 and less than 1 according to a uniform distribution.

4. The data augmentation method according to claim 2, wherein generating the at least one extended input data sample according to the input samples in the at least two different sets of samples and the at least one random number, and generating the at least one extended output data sample according to the output samples in the at least two different sets of samples and the at least one random number, includes:
obtaining an extended input data sample through calculation according to x=α·x₁+(1−α)·x₂; and
obtaining an extended output data sample corresponding to the extended input data sample through calculation according to y=α·y₁+(1−α)·y₂;
wherein α is a random number, x and y are respectively the extended input data sample and the extended output data sample corresponding to the extended input data sample. x₁ and y₁ are respectively an input sample and an output sample of a set of samples, and x₂ and y₂ are respectively an input sample and an output sample of another set of samples.

5. The data augmentation method according to claim 1, wherein before selecting the at least two different sets of samples from the original data set, the data augmentation method further comprises:
performing a first image processing on input samples in the original data set, the first image processing including at least one of inverting, translating or rotating images of the input samples.

6. A method of training a supervised learning system, comprising:
augmenting a data set for training the supervised learning system based on the data augmentation method according to claim 1; and
training the supervised learning system using the data set.

7-12. (canceled)

13. A non-transitory computer-readable storage medium having stored computer program instructions thereon, wherein the computer program instructions, when run on a processor, cause the processor to perform the data augmentation method according to claim 1.

14. A computer device, comprising:
a memory configured to store at least one of an initial result, an intermediate result, or a final result;
and
at least one processor configured to perform;
selecting at least two different sets of samples from an original data set, each set of samples including input samples and output samples;
generating at least one random number; and
generating at least one extended input data sample according to input samples in the at least two different sets of samples and the at least one random number, and generating at least one extended output data sample according to output samples in the at least two different sets of samples and the at least one random number, each extended input data sample corresponding to a respective extended output data sample.

15. The data augmentation method according to claim 1, wherein before selecting the at least two different sets of samples from the original data set, the data augmentation method further comprises:
performing a second image processing on input samples in the original data set, the second image processing including changing at least one of a direction, a position, a ratio, or brightness of images of the input samples.

16. The data augmentation method according to claim 1, wherein before selecting the at least two different sets of samples from the original data set, the data augmentation method further comprises:
performing a first image processing on input samples in the original data set, the first image processing including at least one of inverting, translating or rotating images of the input samples; and
performing a second image processing on the input samples in the original data set, the second image processing including changing at least one of a direction, a position, a ratio, or brightness of the images of the input samples.

17. A non-transitory computer-readable storage medium having stored computer program instructions thereon, wherein the computer program instructions, when run on a processor, cause the processor to perform the method of training the supervised learning system according to claim 6.

18. The computer device according to claim 14, wherein the processor is further configured to perform:
generating the at least one random number greater than 0 and less than 1.

19. The computer device according to claim 18, wherein the processor is further configured to perform:
generating the at least one random number greater than 0 and less than 1 according to a uniform distribution.

20. The computer device according to claim 18, wherein the processor is further configured to perform:
obtaining an extended input data sample through calculation according to x=α·x₁+(1−α)·x₂; and
obtaining an extended output data sample corresponding to the extended input data sample through calculation according to y=α·y₁+(1−α)·y₂;
wherein α is a random number, x and y are respectively the extended input data sample and the extended output data sample corresponding to the extended input data sample, x₁ and y₁ are respectively an input sample and an output sample of a set of samples, and x₂ and y₂ are respectively an input sample and an output sample of another set of samples.

21. The computer device according to claim 14, wherein the processor is further configured to perform:
before selecting the at least two different sets of samples from the original data set, performing a first image processing on input samples in the original data set, the first image processing including at least one of inverting, translating or rotating images of the input samples.

22. The computer device according to claim 14, wherein the processor is further configured to perform:
before selecting the at least two different sets of samples from the original data set, performing a second image processing on input samples in the original data set, the second image processing including changing at least one of a direction, a position, a ratio, or brightness of images of the input samples.

23. The computer device according to claim 14, wherein the processor is further configured to perform:
before selecting the at least two different sets of samples from the original data set, performing a first image processing on input samples in the original data set, and performing a second image processing on the input samples in the original data set; the first image processing including at least one of inverting, translating or rotating images of the input samples, and the second image processing including changing at least one of a direction, a position, a ratio, or brightness of the images of the input samples.

24. A computer device, comprising:
a memory configured to store at least one of an initial result, an intermediate result, or a final result; and
at least one processor configured to perform:
augmenting a data set for training a supervised learning system based on the data augmentation method according to claim 1; and
training the supervised learning system using the data set.
